(19) United States
(12) Patent Application Publication
(10) Pub. No.: US 2012/0208687 A1
(43) Pub. Date: Aug. 16, 2012

(54) FINAL FOLDER FOR CARDBOARD PACKER

(76) Inventors: Max Hanquist, Lund (SE); Jonas Arildsson, Malmo (SE)

(21) Appl. No.: 13/391,024

(22) PCT Filed: Aug. 17, 2010
(86) PCT No.: PCT/SE10/00204

§ 371 Date: May 3, 2012

(30) Foreign Application Priority Data
Aug. 17, 2009 (SE) 091084.4

(51) Int. Cl. B31B 1/00

(52) U.S. Cl. 493/180

(57) ABSTRACT

A folding unit for a cardboard packer is disclosed, which is adapted to close and seal a lid of a cardboard box. The folding unit comprises a conveyor for transporting the cardboard box to the folding unit, a transport device for moving the box and/or a folding device into contact with each other, and further also a catch that is arranged adjacent the conveyor for stopping the box at a folding position, wherein the folding unit further comprises a sensor for detecting when the catch has stopped a box, for activating the transport device such that the box can be final folded.

### FIELD OF THE INVENTION

The present invention relates to a unit for final folding a cardboard blank in a cardboard packer.

### BACKGROUND OF THE INVENTION

In the following description, the term package is used in its widest sense to indicate any container for packaging liquid or pourable food products, and therefore includes not only packages made of multilayer sheet material and similar, to which reference is made hereinafter purely, by way of example, but also glass or plastic bottles, tins etc.

As is known, many pourable food products, such as fruit juice, UHT (Ultra High Temperature treatment) milk, wine, tomato sauce, etc., are sold in packages made of sterilized sheet packaging material.

A typical example of this type of package is the parallelepiped-shaped package for liquid or pourable food products known as Tetra Brik Aseptic (registered trademark), which is made by folding and sealing laminated strip packaging material. The packaging material has a multilayer structure comprising a layer of base material, e.g. paper, covered on both sides with layers of heat-seal plastic material, e.g. polyethylene. In the case of aseptic packages for long-storage products, such as UHT milk, the packaging material also comprises a layer of oxygen-barrier material e.g. aluminium foil, which is superimposed on a layer of heat-seal plastic material, and is in turn covered with another layer of heat-seal plastic material eventually forming the inner face of the package contacting the food product.

As is known, packages of this sort are produced on fully automatic packaging lines, on which a continuous tube is formed from the web-fed packaging material; the web of packaging material is sterilized, e.g. by applying a chemical sterilizing agent such as hydrogen peroxide solution, which is subsequently removed from the surfaces of the packaging material, e.g. evaporated by heating; and the web of packaging material so sterilized is maintained in a closed, sterile environment, and is folded and sealed longitudinally to form a vertical tube.

The tube is filled with the sterilized or sterile-processed food product, and is sealed and subsequently cut along equally spaced cross sections to form pillow packs, which are folded mechanically to form respective finished, e.g. substantially parallelepiped-shaped, packages.

If the packages are not folded at all, a pillow-shaped package with the trademark Tetra Fino is produced, and if only one end wall is folded, a package known by the trademark Tetra Wedge is produced. It is also possible to create tetrahedral-shaped packages, by transversally sealing the vertical Lube in alternating, orthogonal directions, producing packages with the Tetra Classic trademark.

Alternatively, the packaging material may be cut into blanks, which are formed into packages on forming spindles, and the packages are filled with the food product and sealed. One example of this type of package is the so-called “gable-top” package known by the trademark Tetra Rex (registered trademark).

In all of the above cases, the finished packages can be transported successively to a distribution unit, such as a cardboard packer, for protecting the packages during transport from the filling site to the point of sale of the packages. The cardboard packer typically comprises several units, such as an in-feed of blanks, a carton riser, where the blanks are formed to an open box, a pick-and-place station, where packages are taken from a conveyor and are placed inside the open box, and finally a final fold and out-feed of finished boxes. In this last station, the lid of the cardboard box is typically closed and the flaps of the lid are supplied with adhesive and are pressed against the sides of the box, effectively shutting the box in a secure way. The present invention relates to the final fold and out-feed station, and especially to the final fold unit.

Various kinds of devices have been presented for final folding an open box, and feeding the boxes to the out-feed. Those devices normally involve a lot of motors and sensors, and are consequently costly.

It is hence an object of the present invention to present a low-cost and robust solution, at least partly solving the above problems of the prior art.

### SUMMARY OF THE INVENTION

According to the present invention, there is provided a folding unit for final folding a cardboard box, as claimed in claim 1.

### BRIEF DESCRIPTION OF THE DRAWINGS

A preferred, non-limiting embodiment of the present invention will be described by way of example with reference to the accompanying drawings, in which:

FIG. 1 shows a side view of a final fold and out-feed station according to the invention,

FIG. 2 shows an enlarged view of the final fold station of FIG. 1,

FIG. 3 shows an enlarged view of a catch of the final fold station of the present invention,

FIGS. 4 and 5 show an enlarged view of a flap presser of the present invention, in a deactivated and an operative position,

FIG. 6 shows a simplified cross-section of conveyor and box lifting means according to the invention, and

FIGS. 7a-7d show a side view of the final fold and out-feed station, in which a cardboard box is taken through the different steps in the final fold and out-feed station.

### DETAILED DESCRIPTION OF THE INVENTION

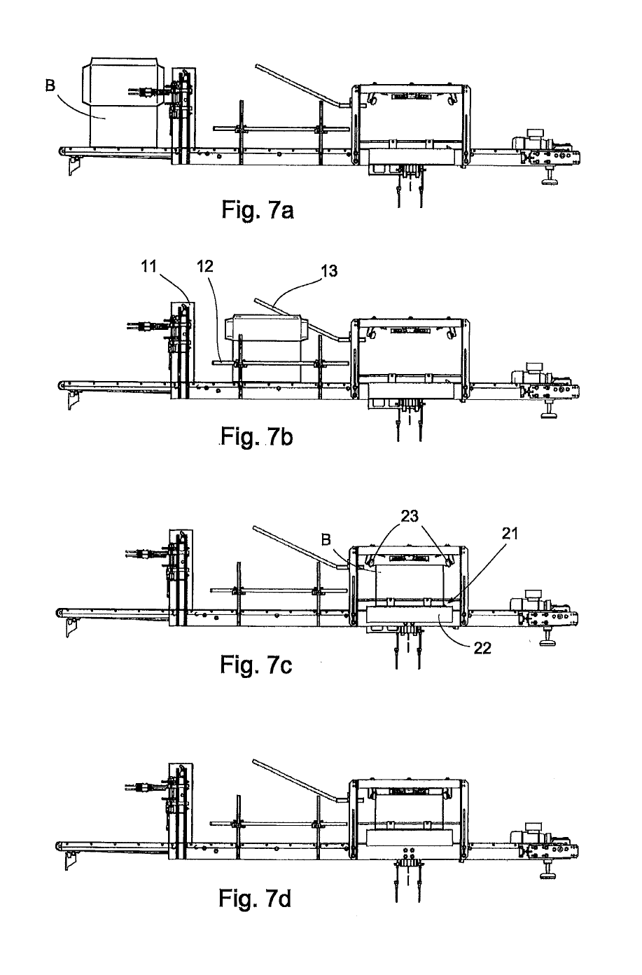

A final fold and out-feed station of a cardboard packer is denoted in general with 1, as can be seen in FIG. 1. This station comprises an endless conveyor 10, preferably continuously running, a hot-glue applicator 11, potentially having several hot-glue nozzles, a guide 12, a folding bar 13, a body 14, and a conveyor drive 15. The conveyor drive 15 propels the conveyor 10, such that a flow of boxes (shown in FIGS. 7a-7d) can be created from the inlet end, to the left in FIG. 1, towards the outlet end, to the right in FIG. 1, according to arrow A.

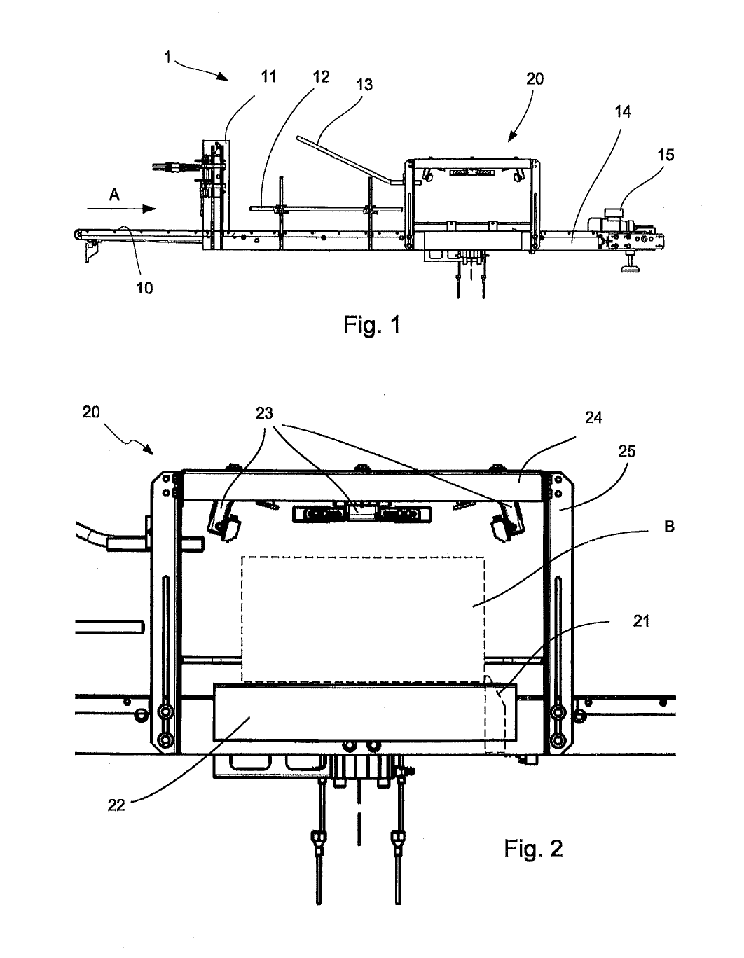

The station 1 also comprises a final fold unit, denoted in general with 20 and shown in more detail in FIG. 2, and the unit 20 is mounted on the body 14, straddling the conveyor 10. The folding bar 13 is in the shown embodiment mounted on the folding unit 20, but can just as well be mounted on the body 14. The folding bar 13 is angled horizontally, as is shown in FIG. 1, but is also angled sideways, from the left side (as seen from the inlet end) to the right side. This enables the folding bar 13 to catch the open, vertical lid and gradually bring it to the horizontal position as shown in FIG. 7c.

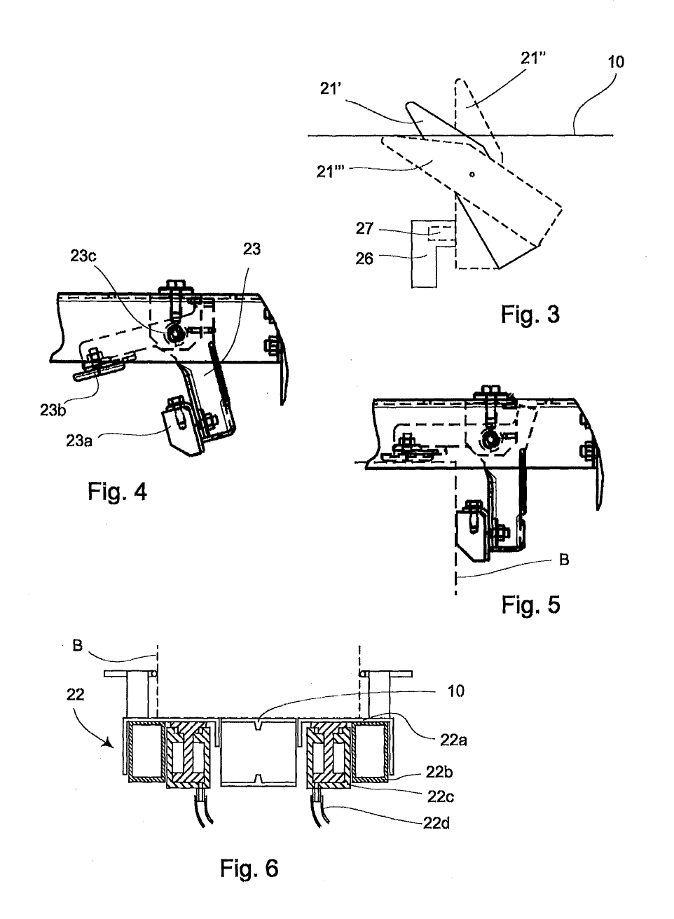

The folding unit 20 comprises a catch 21, shown with phantom lines in FIG. 2 and in more detail in FIG. 3. The catch 21 may be mounted on the body 14. The catch 21 protrudes slightly above the level of the conveyor 10, and a box lifting arrangement 22, adjacent to the conveyor 10. The unit 20 further comprises several flap folders 23. The flap folders may be mounted at a top bar 24 of a frame 25 of the folding unit 20. Further, a general box B is shown with phantom lines in FIG. 2.

The catch 21 is shown in more detail in FIG. 3, in three different positions. The central position, denoted 21′, represents the rest position of the catch 21, and a spring (not shown) can be arranged to automatically bring the catch 21 back to this rest position. The position 21″ represents an operative position, in which the catch 21 has been moved from the rest position 21′ by a box B moving on the conveyor 10. The catch 21 is in this position caught by a stop 26. The stop 26 may comprise a sensor 27, indicated generally with phantom lines in FIG. 3. The presence of a box B against the catch 21 is now sensed by the sensor 27, and the box is held stationary against the one, two or more catches, on the continuously running conveyor 10.

In an embodiment, the sensor 27 may be arranged at a distance from the catch 21, however configured to detect when the catch is in the operative position 21″. The conveyor 10 can e.g. be made of a relatively slick material, which does not damage the box B when it is held stationary on top the moving conveyor surface. The deactivated position 21′″ of the catch 21 shows the position the catch 21 assumes when a box B has been lifted up, for final folding, and then is placed back on the conveyor 10. After having stopped the box B, the box is lifted upwards, releasing the catch to again assume the rest position 21′. The box is then placed on the catch 21, which now pivots the other way, counter-clockwise in FIG. 3, such that the box B can transported further downstream by the conveyor 10. To this end, when the box B is lowered down onto the conveyor 10, the bottom of the box B will push the catch 21 into the deactivated position 21′″, overcoming the spring force of the spring (not shown) seeking to bring the catch into the rest position 21′. To facilitate the operation of pushing the catch 21 into the deactivated position 21′″, the catch 21 has a horizontally slanted top surface in its rest position 21′. In this way, the sliding action of the bottom of the box B on the catch 21 is facilitated, whereby movement of the catch 21 into the deactivated position 21′″ is assured.

FIG. 4 shows a flap folder 23 in a first rest position, in which it is ready to accept a box B for final folding of the lid and of the flaps of the lid. This position corresponds to the natural position the flap folder 23 assumes due to mass balance, and it does not need any further actuator. If needed, a spring or similar (not shown) can be fitted to more directly bring the flap folders to this position.

The flap folder 23 may have a general L-shape. Also, the flap folder 23 may have substantially equally long legs. On the substantially vertically extending leg the flap folder may comprise a first pressure pad 23a, for pressing a flap against the side of the box B. On the substantially horizontally extending leg the flap folder may comprise a second pressure pad 23b, for pressing on the top of the lid of the box B. The final folder 23 is supported by pivot 23c, about which the final folder 23 is freely pivotable (depending on the presence or not of a potential spring).

FIG. 5 shows the flap folder 23 in a work position, in which the first 23a and second pressure pad 23b press on the side and top of the lid of box, shown partly with phantom lines, such that one leg of the flap folder 23 extends vertically and the other leg extends horizontally.

FIG. 6 shows a cross-section of a generalized structure of the conveyor 10 and box lifting arrangement 22. In the shown embodiment, there is a central conveyor 10, and a box lifting table 22a. A reinforcing frame 22b is mounted to the box lifting table 22a. A hydraulic or pneumatic actuator 22c is further mounted to the under-side of the box lifting table 22a, and is also connected to the body 14. The actuator 22c can be fed with a working fluid, such as hydraulic oil or pressurized air, through a hose 22d. When a box B is conveyed into the final folding unit 20, the box lifting table 22a is preferably slightly below the level of the conveyor 10. As soon as the box has pressed the catch 21 into activation of the sensor 27, the lifting arrangement 22 pushes upwards and lifts the box B into the folding means 23. It is also possible to have an arrangement in which the folding means 23 is driven down onto the box B, upon signal from the sensor 27. The lifting arrangement and/or the means for transporting the folding means 23 downwards are generally referred to as transport means and is denoted as 22.

The operation and function of the final fold and out-feed station 1 will now be described in more detail.

In FIG. 7a, a box B filled with packages (packages not shown) is brought to the inlet end of the conveyor 10, which starts transporting the box to the right in FIG. 7a. In FIG. 7b, the box has passed the hot-glue station 11, which has supplied the lid with several applications of hot-glue for gluing the lid to the box B. These applications are indicated in FIG. 7b with lines on the lid, at the top of the box B. In the position shown in FIG. 7b, the folding bar 13 has started the initial folding of the lid, towards the open box B. The box B is guided on the conveyor 10 by the guide 12, against the pushing of the folding bar 13.

In FIG. 7c, the box B has been brought against the catch 21, which is then brought from its rest position 21′ to its working position 21″, where the catch 21 is stopped by the stop 26, which in turn makes catch 21 stop the box B on the conveyor 10. The catch 21 further activates sensor 27, and the system is alerted that a box B is in position inside the final fold unit 20.

The box lifting arrangement or transport means 22 is now activated transporting the box upwards, away from the conveyor 10 and towards the flap folders 23 (or the flap folders 23 are transported downwards over the box). In FIG. 7c, two of the flap folders 23 have just started folding the side flaps of the lid towards the side of the box B. Further lifting and/or action of the transport means 22 will place the box B in the position shown in FIG. 7d. Here, flap folders 23 on all sides of the box B securely press the flaps of the lid against the sides of the box B, such that the adhesive on the flaps can cure and hold the lid in place. During the lifting motion and/or action of the transport means 22 of the box B, the catch 21 has resumed its resting position 21′, as shown in FIG. 3. The first pressure pad 23a presses against the flaps of the lid, whereas the second pressure pad 23b of each flap folder 23 presses against the top of the lid. All the force of the flap folders 23 is given by the transport means 22.

The box is then lowered towards the conveyor 10, and the box B now presses the catch 21 to the position 21′″, as also shown in FIG. 3. In this position, the catch 21 does not hinder the box B from being transported by the conveyor 10, and the box B is consequently moved towards the outlet by the conveyor 10, to the right in FIG. 7d, where it is handled by further downstream equipment for subsequent delivery at a customer. In the case where the flap folders 23 are lowered onto the box, a separate release of the catch 21 should be installed. Such a release could for example be actuated when the flap folders are lifted from the box B. In this case the stop 26 may be lowered or releasingly pivoted away from its stopping position into a released position, such that the catch 21 no longer is stopped in its vertical position 21′″. A further spring (not shown) could then be mounted to return the catch 21 into its resting position, after the box B has passed the catch 21. Only the further spring (not shown) then pulls the catch towards its resting position, but the weight of the box B overcomes this force. Thus, the box B may be further transported to the right in FIGS. 7a to 7d. When the box B has passed the catch 21, the further spring (not shown) returns the catch 21 into its resting position 21′. Then the stop 26 is returned from its released position into its stopping position.

When the box B is lowered from the flap folders 23 or the flap folders 23 are lifted, the flap folders 23 resume their rest position as can be seen in FIG. 5, due to the mass balance of said folders 23.

The system hence comprises a preferably continuously moving conveyor 10, which can be driven by a cheap motor in the conveyor drive 15. No sensors are needed for on-off control. The box lifting arrangement 22 is activated when the catch 21 is moved to position 21″, by box B being transported by conveyor 10 and interacting with the catch 21. Flap folders 23 are then activated by the box lifting arrangement 22, which only needs to lift the box B into contact with the flap folders 23 and/or lower the flap folders 23 into contact with the box B and with a set force, and release the pressure after a predetermined time period. The catch 21 is then automatically deactivated, as soon as the box B is lifted up towards the flap folders 23, and the box B can be transported further downstream.

The sensor 27 is in one embodiment a conductive switch, but any contact or proximity switch is suitable that can detect the movement of the catch 21 to the position 21″.

The flap folders 23 are adjustable inwards or outwards of the centre of the frame 25, in order to be able to handle boxes of different sizes. This adjustability can be done in several different ways, as is known to a person skilled in the art. Similarly, the folding bar 13 can in one embodiment be adjustable, to be able to adequately fold the lid of boxes with different heights. The adjustment of the flap folders 23 or the folding bar 13 is relatively easy and is typically performed manually, but it is of course obvious to a person skilled in the art that the adjustment for different sizes can be performed automatically. Also the height of the flap folders 23 above the conveyor is adjustable in a way known per se.

The term flap folder is used together with the term flap folding means (folding means) to refer to the general means 23 for folding the flaps of the lid onto the sides of the box. The term box lifting arrangement is used alternately with the term transport means to refer to the general means 22 for moving the box B and folding means 23 into engagement with each other.

1. A folding unit for a cardboard packer, being adapted to close and seal a lid of a cardboard box, comprising:
a conveyor for transporting the cardboard box to the folding unit;
a transport means for moving the box and/or a folding means into engagement with each other;
a catch arranged adjacent the conveyor for stopping the box at a folding position; and
wherein the folding unit further comprises a sensor for detecting when the catch has stopped a box, for activating the transport means such that the box can be final folded.

2. A folding unit as claimed in claim 1, wherein the catch comprises the sensor.

3. A folding unit as claimed in claim 1, wherein the transport means is a box lifting arrangement, lifting the box towards a substantially stationary folding means.

4. A folding unit according to claim 3, wherein the catch, after lifting of the box, returns to a rest position in which the box will not be stopped by the catch when it is lowered back onto the conveyor after final folding.

5. A folding unit according to claim 1, wherein the conveyor is a continuously driven endless belt.

6. A folding unit according to claim 1, wherein the conveyor is manufactured from a slick material, such as PTFE.

7. A folding unit according to claim 1, wherein the folding means have a general L-shape, are pivotally suspended at the bend, and have a pressure pad at each outwardly leg of the L-shape.

8. Folding A folding unit according to claim 1, wherein the folding means each are pivotally suspended above the conveyor and has a rest position, determined by the center of gravity in relation to a pivot point thereof, for accepting a box B to be inserted and final folded.

9. Folding A folding unit according to claim 3, wherein a folding movement and a folding force is given by the lifting movement of the box by the lifting arrangement.

10. A folding unit according to claim 1, wherein the folding means are adjustable in three dimensions, in order to accept boxes of different sizes.

11. A folding unit according to claim 2, wherein the catch during operation assumes three positions: an operative position, in which the box has pushed the catch to trigger a contact sensor and the box is held stationary by the catch, a rest position, which the catch naturally assumes if not affected by a box, and a deactivated position, which the catch assumes when a box is lowered onto the catch and in which the box is not stopped.
